(19) United States
(12) Patent Application Publication
(10) Pub. No.: US 2024/0308125 A1
(43) Pub. Date: Sep. 19, 2024

(54) METHOD FOR PRODUCING A BAG WITH AN ANTI-ADHESION LAYER, AND BAG WITH ANTI-ADHESION LAYER

(71) Applicant: JURA-PLAST GMBH, Reichenschwand (DE)

(72) Inventor: Herbert Jürgen MÜLLER, Happurg/Förrenbach (DE)

(21) Appl. No.: 18/675,262

(22) Filed: May 28, 2024

Related U.S. Application Data
(63) Continuation of application No. 16/093,789, filed on Oct. 15, 2018, now abandoned.

(30) Foreign Application Priority Data
Apr. 15, 2016 (EP) 16165695.4

(51) Int. Cl. B29C 48/08; B29C 48/00; B29C 65/00; B29C 65/02; B29K 705/02; B29L 31/00; B31B 70/64; B31B 70/74; C08G 77/458

(52) U.S. Cl. CPC B29C 48/08; B29C 48/00; B29C 65/02; B29C 66/4322; B29C 66/71; B29C 66/723; B29C 66/72321; B29C 66/72328; B31B 70/64; B31B 70/79; C08G 77/458; B29C 2795/00; B29K 2705/02; B29L 2031/7128

(57) ABSTRACT

The present invention relates to a method for producing a bag-shaped package made of plastic, wherein the bag-shaped package is equipped with an anti-adhesion layer on the basis of polydiorganosiloxane which is weldable, and the bag-shaped package is produced by welding or sealing on the side with the anti-adhesion layer, and also to a bag-shaped package that can be produced by the method according to the invention, and to the use of a weldable plastic based on polydiorganosiloxane with anti-adhesion properties for the production of a bag-shaped package by means of welding or sealing.

The present invention relates to the production of plastic bags, in particular by means of a plastic welding method.

In particular, the present invention relates to the production of plastic bags, which are equipped with an anti-adhesion layer, by means of a welding method.

The term “bag” is used here representatively for all bag-shaped packages made of plastic, such as carrier bags, shopping bags, sack-shaped packages, etc.

The inner side of plastic bags is often provided with an anti-adhesion layer so as to prevent the adhesion of tacky, pasty packaged goods and so as to facilitate their removal from the bag.

For the production of plastic bags, films are produced from thermoplastics, two film portions are placed one over the other, and the side edges and optionally the lower edge are welded to one another.

Typical thermoplastics for the production of bags are polyolefins, such as polyethylene (PE), polypropylene (PP), polyamides (PA), polyethylene terephthalates (PET) etc.

In order to prevent an adhesion of the packaged goods to the film, the inner face of the bag is usually equipped with an anti-adhesion coating, for example made of polydiorganosiloxanes (also referred to hereinafter as silicone) such as polydimethylsiloxane.

The silicone is applied here in liquid form to the carrier film and is cured, wherein a coating adhering fixedly to the carrier film is formed.

It is disadvantageous here that polydiorganosiloxanes, as elastomers, cannot be welded, in contrast to thermoplastics.

Nowadays, the carrier film is therefore produced first, and in a second process step one side of the film is provided with the anti-adhesion coating formed from polydiorganosiloxane. Since the polydiorganosiloxane cannot be welded, the film is welded on the uncoated, opposite side, to form a bag. The bag must then be turned inside out so that the coated side comes to be on the inside, this usually still being done by hand.

This production process is decidedly complex from a manufacturing viewpoint.

Further disadvantages besides the complex manufacture are that the protruding seams of the bag protrude into the interior of the bag and the manufacturing quality of the coating with the silicone material is inconsistent. In addition, there is a high immission load as a result of silicone-containing waste gas.

The object of the present invention was therefore that of providing a simplified method for the production of plastic bags provided with an anti-adhesion coating, wherein in particular the complex process involving turning the bag inside out is to be avoided.

This object is achieved in accordance with the invention by using, for the production of an anti-adhesion coating for a bag-shaped package, a plastic based on polydiorganosiloxane which is weldable.

In particular, the present invention relates to a method for producing a bag-shaped package from a film having an anti-adhesion layer, wherein the anti-adhesion layer is formed from a plastic based on polydiorganosiloxane which is weldable, wherein in a first step the film with anti-adhesion layer is produced and in a second step the film is processed by welding or sealing on the side with anti-adhesion layer to form a bag-shaped package.

The present invention also relates to a bag-shaped package having at least one weldable anti-adhesion layer based on polydiorganosiloxane on the inner side, wherein the bag-shaped package is welded or sealed on the side having the anti-adhesion layer.

In accordance with a further aspect the present invention relates to the use of a weldable plastic based on polydiorganosiloxane with anti-adhesion properties as anti-adhesion layer for a bag-shaped packaging which is produced by means of welding, wherein the welding or sealing is performed on the side with the weldable plastic based on polydiorganosiloxane.

Since, for the present invention, a weldable plastic based on polydiorganosiloxane is used as anti-adhesion layer, the film can be welded directly on the “correct” side to form a bag, and therefore the complex process involving turning the bag inside out is no longer necessary.

The weldable anti-adhesion layer can be processed directly by means of conventional welding and sealing methods.

In addition, the weldable plastics based on silicone can also be readily processed by conventional extrusion methods including blow film extrusion and cast film extrusion. This means that the film with anti-adhesion layer can be obtained in a single process step by extrusion, such that the subsequent application of the anti-adhesion layer is also spared.

The film can be a monolayer film or a co-extruded multilayer film formed from two or more film layers. The further film layers can be produced from other plastic materials.

The further film layers can be functional layers having specific functions, for example a barrier layer with respect to gases or steam, a layer for promoting adhesion between incompatible polymers, for influencing the mechanical properties of the film, stability, etc.

The film can be provided on both sides with an anti-adhesion layer.

The weldable film with anti-adhesion layer or the weldable anti-adhesion layer can be processed by means of conventional methods. It can be finished as necessary, for example printed or laminated with films made of other materials (other plastics, paper, metals such as aluminium, etc.). This finishing does not impair the weldability or sealability of the weldable anti-adhesion layer, and therefore this can still be welded also following the finishing.

A further example of a possible use of a film having a weldable anti-adhesion layer is the use as a flat film on what are known as FFS (form-fill-seal) systems, in which the film only at the time of packing is processed to form bags or sacks of a wide range of forms, formats, and structure.

Depending on requirements, additives and/or fillers can be added, as are known and conventional in the plastics processing industry.

Examples of conventional fillers are quartz flour, chalk, mica, aluminium oxide hydrates, pyrogenic and precipitated silicas and silicate aerogels.

Examples of conventional additives are dyes, pigments, anti-blocking agents and anti-fogging agents. Examples of pigments are titanium dioxide, calcium carbonate and silicon dioxide, which give the film a pearlescent sheen.

The auxiliaries can also be added as masterbatches, for example as a filler masterbatch or colour masterbatch.

In principle, any weldable polymer or copolymer based on polydiorganosiloxane which has anti-adhesion properties can be used for the present invention. Examples of this are in particular thermoplastic polydiorganosiloxane copolymers and thermoplastic elastomers based on polydiorganosiloxane.

The block copolymers known per se can be used with soft nonpolar polydiorganosiloxane block and one or more hard polar polymer blocks. Thermoplastics are suitable as polymers for the hard polymer blocks. Examples of hard polymers are polyamide, polyester, polyurethane, polyurea, vinyl copolymers, novolak, polycarbonate, polystyrene, polycaprolactone, polysulfone, etc.

The soft polymer block can also contain, in addition to polydiorganosiloxane, one or more other soft polymer blocks. Examples of this are polyalkylene oxide, polyolefin, polydiene, or polyfluorocarbon.

For example, the soft polymer block can be a di-or triblock copolymer with polydiorganosiloxane and polyethylene oxide or polypropylene oxide.

Preferred blocks are polydimethylsiloxane, polydialkylsiloxane, polyfluoroalkyl-alkylsiloxane, polydiarylsiloxane and polyaryl-alkyl-siloxane.

The organogroups of the silicon atoms of the polydiorganosiloxane block can be the same or different. They can be selected, inter alia, from a linear or branched alkyl with C₁-C₁₈, a cycloalkyl, alkenyl, aryl, arakyl, a halogenated alkyl, a halogenated aryl and a halogenated alkyl.

The number of repetition units in the soft block can vary within a wide range and for example can be between 1 and approximately 4000, is preferably at least 3, and particularly preferably at least 5, and preferably at most 1500 and particularly preferably at most 600 repetition units.

The number of repetition units in the hard blocks is typically less than the number of repetition units in the soft blocks and can be 1 to 10 repetition units, wherein the number of repetition units in the hard blocks is usually the same as or less than the number of repetition units in the soft blocks.

The block copolymer can have blocks of different hardness, for example a first block made of a first hard polymer and a second block made of a second hard polymer.

Suitable examples of block copolymers with soft polydiorganosiloxane blocks and methods for the production thereof are described for example in WO 91/15538 A1 (ALLLIED-SIGNAL INC.), WO 96/0340029 (corresponding to EP 0 822 951 B1; Minisota Mining and Manufacturing Company) and DE 10 2004 062 354 A1 (Wacker Chemie AG).

A method for producing polydiorganosiloxane/polyurea block copolymers is described for example in I. Yilgör, Polymer, 1984 (25), 1800. Thereafter, α,ω-bis(aminoalkyl)polydimethylsiloxane oligomers are reacted with conventional diisocyanates as hard blocks by means of a polyaddition reaction known per se. Polydiorganosiloxane/polyurethane block copolymers or polydiorganosiloxane/polyurea/polyurethane block copolymers can be obtained in a similar way.

A further suitable material for the present invention is an elastomer alloy with a microheterogeneous phase distribution of a silicone elastomer in a thermoplastic material. In principle, any known silicone elastomer can be used for this purpose. The proportion by weight of silicone elastomer is advantageously lower than that of the thermoplastic material. Examples of suitable thermoplastic materials are the above-mentioned materials for the hard blocks.

The present invention enables a significant simplification of the production of bag-like packages having a layer with anti-adhesion properties based on polydiorganosiloxanes by means of conventional welding/sealing techniques. Multilayer films can be obtained readily by a conventional coextrusion method, which films, in addition to the anti-adhesion layer, can also be adapted to requirement profiles in respect of the mechanical properties, permeation, stability, etc.

1.-9. (canceled)

10. A method for producing a bag-shaped package made of a film having an anti-adhesion layer, wherein the anti-adhesion layer is formed from a plastic based on polydiorganosiloxane which is weldable,
which comprises in a first step the film with anti-adhesion layer is produced and in a second step the film is processed by welding or sealing on the side having the anti-adhesion layer to form the bag-shaped package,
wherein the plastic based on polydiorganosiloxane is a block copolymer with one or more blocks formed from polydiorganosiloxane and one or more blocks formed from a hard polymer selected from a thermoplastic, and
wherein the hard block is selected from polyamide, polyester, polycarbonate, polyurethane, polycaprolactone, polyurea, polycarbonate, polystyrene, polysulfone, novolak and copolymers thereof.

11. The method according to claim 10, wherein the film with anti-adhesion layer is obtained by extrusion.

12. The method according to claim 10, wherein the film is a multilayer film having two or more layers, wherein one side is an anti-adhesion layer made of a plastic based on polydiorganosiloxane.

13. The method according to claim 10, wherein the weldable plastic based on polydiorganosiloxane is an elastomer alloy, in which polydiorganosiloxane is finely distributed in a matrix formed from a thermoplastic.

14. The method according to claim 10, wherein the film with anti-adhesion layer is laminated with a non-plastic material.

15. The method according to claim 14, wherein the non-plastic material is a film made of paper, cardboard or a metal.

16. The method according to claim 10, wherein the block copolymer comprises at least one chain extender.

17. A bag-shaped package obtainable by a method according to claim 10, wherein the inner side of the bag-shaped package has anti-adhesion properties and is formed from a weldable plastic based on polydiorganosiloxane, wherein the bag-shaped package is formed by welding on the inner side with the anti-adhesion layer.
